(19) United States
(12) Patent Application Publication
(10) Pub. No.: US 2009/0026405 A1
(43) Pub. Date: Jan. 29, 2009

(54) LEAK RESISTANT BY-PASS VALVE

(75) Inventors: JEFF SHEPPARD, Milton (CA); DARIO BETTIO, Mississauga (CA); MARK S. KOZDRAS, Oakville (CA)

Correspondence Address: RIDOUT & MAYBEE LLP, 225 KING STREET WEST, 10TH FLOOR, TORONTO, ON, M5V 3M2, CA

(73) Assignee: DANA CANADA CORPORATION, Oakville (CA)

(21) Appl. No.: 11/828,806

(22) Filed: Jul. 26, 2007

(51) Int. Cl. F16K 31/64

(52) U.S. Cl. 251/364

(57) ABSTRACT

A by-pass valve that includes a housing defining a chamber therein, and a by-pass valve port and a first port communicating with the chamber. The by-pass valve port has a central axis and a peripheral valve seat. The by-pass valve also includes a valve assembly comprising a central shaft disposed along said central axis, and an annular ring slidably mounted on the central shaft for movement between a closed position in which the annular ring engages the valve seat and an open position in which the annular ring is spaced apart from the valve seat, the annular ring having a cylindrical inner surface surrounding the central shaft with a first circumferential rib extending inward from a portion of the inner surface and slidably engaging the central shaft.

### BACKGROUND

Embodiments described herein relate to by-pass valves.

In certain applications, such as in the automotive industry, heat exchangers are used to cool or heat certain fluids, such as engine oil or transmission fluid or oil. In the case of transmission fluid, for instance, a heat exchanger is used to cool the transmission fluid. The heat exchanger is usually located remote from the transmission and receives hot transmission oil from the transmission through supply tubing, cools it, and delivers it back to the transmission again through return tubing. However, when the transmission is cold, such as at start-up conditions, the transmission oil is very viscous and does not flow easily through the heat exchanger, if at all. In such cases, the transmission can be starved of oil and this may cause damage or at the least erratic performance. Cumulative damage to the transmission can also occur if the quantity of oil returned is adequate, but is overcooled due to low ambient temperatures. In this case, for instance, moisture condensation in the oil (that would otherwise be vaporized at higher temperatures) may accumulate and cause corrosion damage or oil degradation.

In order to overcome the cold flow starvation problem, various solutions have been proposed in the past. One solution is to use a by-pass path between the heat exchanger supply and return lines often with a heat-actuated by-pass valve located in the by-pass path. An example of a by-pass valve is shown in U.S. Pat. No. 6,253,837. Using a thermal by-pass valve to by-pass a cooling element can provide rapid warm up of the oil, which in addition to addressing the concerns noted above can also result in improved fuel economy.

### SUMMARY

According to one example embodiment is a by-pass valve that comprises: a housing defining a chamber therein, and a by-pass valve port and a first port communicating with the chamber, the by-pass valve port having a central axis and a peripheral valve seat; and a valve assembly comprising a central shaft disposed along said central axis, and an annular ring slidably mounted on the central shaft for movement between a closed position in which the annular ring engages the valve seat and an open position in which the annular ring is spaced apart from the valve seat, the annular ring having a cylindrical inner surface surrounding the central shaft with a first circumferential rib extending inward from a portion of the inner surface and slidably engaging the central shaft.

According to another example embodiment is a by-pass valve comprising: a housing defining a chamber therein, and a by-pass valve port and a first port communicating with the chamber, the by-pass valve port having a central axis and a peripheral valve seat; and a valve assembly comprising a central shaft disposed along said central axis, and an annular ring slidably mounted on the central shaft for movement between a closed position in which the annular ring engages the valve seat and an open position in which the annular ring is spaced apart from the valve seat, wherein the annular ring comprises adjacent first and second annular portions each surrounding and slidably mounted to the central shaft, one of the annular portions being formed from a material that is softer than a material that the other annular portion is formed from.

According to another example embodiment is a by-pass valve comprising: a housing defining a chamber therein, and a by-pass valve port and a first port communicating with the chamber, the by-pass valve port having a central axis and a peripheral valve seat; and a valve assembly comprising a central shaft disposed along said central axis, and an annular ring slidably mounted on the central shaft for movement between a closed position in which the annular ring engages the valve seat and an open position in which the annular ring is spaced apart from the valve seat, the annular ring having a cylindrical inner surface surrounding the central shaft with a centering structure extending inward from a portion of the inner surface and slidably engaging the central shaft for keeping the annular ring centered relative to the central shaft.

### BRIEF DESCRIPTION OF THE DRAWINGS

Example embodiments of the invention will now be described with reference to the accompanying drawings, throughout which similar elements and features are denoted by the same reference numbers, and in which:

FIG. 1 is an elevational view, partly in cross-section, of a by-pass valve according to an example embodiment of the invention, showing the by-pass valve in a resting, open position in which fluid by-pass of a heat exchanger is permitted;

FIG. 2 is an elevational view, partly in cross-section, showing the by-pass valve in closed position in which fluid by-pass of a exchanger is minimized;

FIG. 3 is an elevational view of a valve assembly used in the by-pass valve of FIGS. 1 and 2;

FIG. 4 is an elevational view of a closure cap of the by-pass valve of FIGS. 1 and 2;

FIG. 5 is bottom view of the closure cap of FIG. 4;

FIG. 6 is a sectional view of the closure cap, taken along the lines VI-VI of FIG. 5;

FIG. 7 is a perspective view of the closure cap of FIG. 4;

FIG. 8 is a plan view of a annular ring used in the by-pass valve of FIG. 1, according to one example embodiment;

FIG. 9 is a perspective view of the annular ring of FIG. 8;

FIG. 10 is a sectional view of the annular ring, taken along the lines X-X of FIG. 8;

FIG. 10A shows an enlarged portion of FIG. 10;

FIG. 11 is a sectional view showing a first variation of the annular ring;

FIG. 12 is a sectional view showing a second variation of the annular ring;

FIG. 13 is a sectional view showing a third variation of the annular ring;

FIG. 14 is a sectional view showing a forth variation of the annular ring;

FIG. 15 is a sectional view showing a fifth variation of the annular ring;

FIG. 16 is a plan view of a annular ring used in the by-pass valve of FIG. 1, according to another example embodiment;

FIG. 17 is a plan view of a annular ring used in the by-pass valve of FIG. 1, according to another example embodiment; and

FIG. 18 is a partial side view of the by-pass valve of FIG. 1, showing the ribs of a closure cap through valve flow port.

### DESCRIPTION OF EXAMPLE EMBODIMENTS

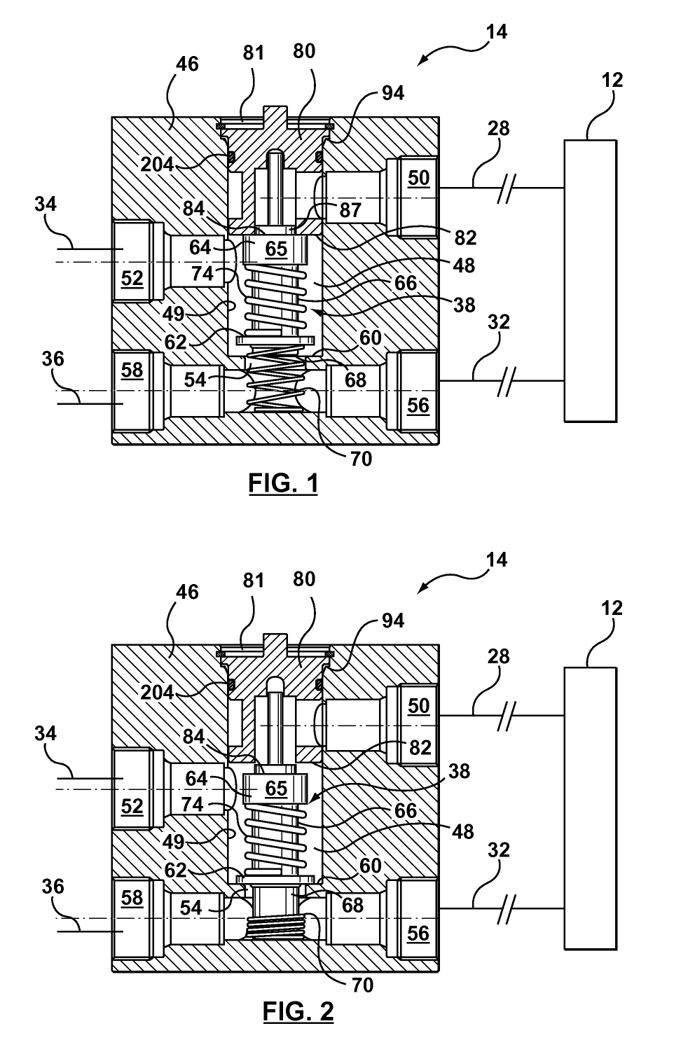

Referring firstly to FIG. 1, there is shown an example of a by-pass valve, indicated generally by reference 14. By-pass valve 14 may be used in a heat exchanger circuit to control the flow a fluid to a heat exchanger 12, to which first and second conduits 28 and 32 are connected. Conduits 28, 32 are connected to inlet and outlet ports in by-pass valve 14 as will be described further below. Conduits 34, 36 are also connected to ports in by-pass valve 14 as will be described further below. By-pass valve 14 is referred to as a four port by-pass valve, because four conduits 28, 32, 34 and 36 are connected to by-pass valve 14.

The by-pass valve 14 has a housing 46 with serially communicating coaxial chamber 48 and valve port 54. In an example embodiment, chamber 36 is substantially defined by a cylindrical wall 49. In an example embodiment, the housing 46 is formed of steel or other metal, or alternatively a moldable material such as a plastic material which may be a thermoplastic or a thermosetting material and which may contain reinforcement such as glass fiber or particulate reinforcement. Housing 46 defines a heat exchanger side inlet opening or port 50 and a main outlet port or opening 52 communicating with the chamber 48 through openings in the chamber wall 49. Chamber 48 communicates through valve port 54 with a heat exchanger side outlet opening or port 56 and with a main inlet opening or port 58. Outlet and inlet conduits 32 and 36 are connected respectively to the outlet and inlet ports 56, 58. Inlet and outlet conduits 28 and 34 are connected to inlet port 50 and main outlet port 52, respectively. Ports 50, 52, 56 and 58 may be internally threaded for receiving threaded end portions of conduits 28, 34, 32 and 36, respectively, however the conduits and ports could alternatively be connected using other methods, including for example molding the ports around the conduits.

Valve port 54 has an annular peripheral valve seat 60 facing chamber 48. In the illustrated embodiment, valve seat 60 is an annular shoulder formed by housing 46 at a transition or junction between chamber 48 and valve port 54. A valve assembly 38 located within housing 14 is operative to open and close the valve port 54. The valve assembly 38 includes an annular ring 62 that is adapted to engage valve seat 60 to open and close valve port 54. Valve assembly 38 includes a temperature responsive actuator 64 operably coupled to annular ring 62 to move annular ring 62 thereby opening and closing valve port 54. Actuator 64 is sometimes referred to as a thermal motor and in one example embodiment it is a piston and cylinder type device wherein the cylinder is filled with a thermal sensitive material, such as wax, that expands and contracts causing the actuator to extend axially upon being heated to a predetermined temperature.

It will be seen from FIGS. 1, 2 and 3 that actuator 64 is located along a central axis of chamber 48 and valve port 54. In an example embodiment, coaxial chamber 48 and valve port 54 are both generally cylindrical, with valve port 54 having a smaller diameter than chamber 48. The cylinder of actuator 64 forms a central shaft 66 disposed along the central axis of chamber 48 and valve port 54. Central shaft 66 has a closed end portion 68 that has a diameter less than that of valve port 54. Annular ring 62 is slidably mounted on central shaft 66, and is located adjacent to closed end portion 68 in its normal or “cold” position as indicated in FIG. 1. In the “hot” position shown in FIG. 2, annular ring extends transversely from the central shaft 66 to engage valve seat 60 to close valve port 54. The annular ring 62 and closed end portion 68 form a reciprocating plug which moves along the central axis to open and close valve opening 53.

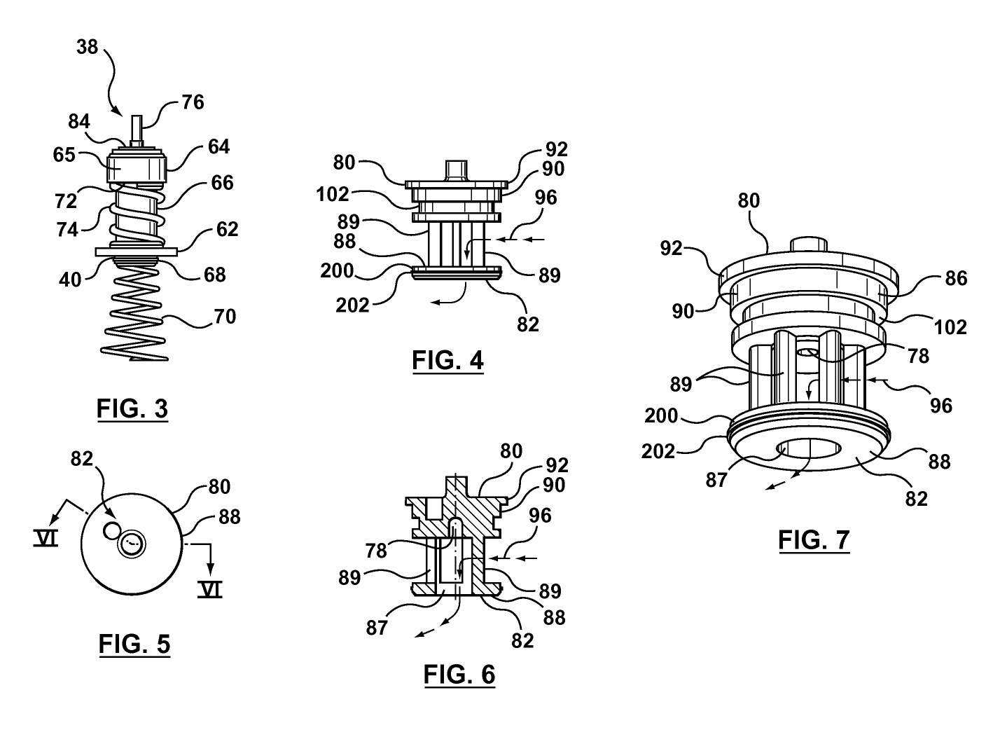

As shown in FIG. 3, the valve assembly includes a return spring 70 that has a first end 40 attached to closed end portion 68 by being located in a groove (not shown) formed in closed end portion 68. The return spring 70 has a stationary second end 42 that engages a surface of housing 46 that opposes the valve port 54. Return spring 70 thus urges the central shaft 66 away from valve seat 60 into its retracted position of FIG. 1, and acts as a stop for preventing annular ring 62 from sliding off central shaft 66 when the ring 62 is lifted off of the valve seat 60 (as shown in FIG. 1). As seen in FIG. 3, in at least some example embodiments, the return spring 70 has a coil diameter that gets larger as the distance from end portion 68 increases, such that the return spring 70 tapers outward from first end 40 to the second end 42, although different return spring configurations are possible, including for example those shown in US Patent Application Publication No. 2006/0108435 published May 25, 2006 (Kozdras et al.).

As best seen in FIG. 3, central shaft 66 includes an inner annular shoulder 72, and an override spring 74 mounted on central shaft 66 between shoulder 72 and annular ring 62. The override spring 74 urges or biases annular ring 62 toward the stop or return spring 70, and thus toward valve seat 60.

As best seen in FIGS. 1 and 2, housing 46 defines an assembly opening 81 to chamber 48 that opposes valve port 54 and through which the valve assembly 38 of FIG. 3 can be inserted into chamber 48 during assembly of the by-pass valve 14. A closure cap 80 (shown in greater detail in FIGS. 4-7) is inserted into the opening 81 to seal the chamber 48 after the valve assembly 38 is in place. In one example embodiment, closure cap 80 may be formed from a moldable material such as a plastic material which may be a thermoplastic or a thermosetting material and which may contain reinforcement such as glass fiber or particulate reinforcement. Closure cap can also in some embodiments be formed from steel or metal materials.

Thermal motor or actuator 64 has a piston 76 (see FIG. 3) that is attached or fitted into an axial recess 78 (see FIG. 6,7) formed in closure cap 80. As will be described in more detail below, when thermal motor 64 reaches a predetermined temperature, it extends axially. Since piston 76 is fixed in position, central shaft 66, which is part of thermal motor 64, moves downwardly through valve port 54 compressing return spring 70. The shoulder 72 moves down with the central shaft and presses on override spring 74 such that the annular ring 62 is biased to engage the valve seat 60 such that the ring 62 and the shaft 66 collectively close the valve port 54. When the temperature inside chamber 48 drops below the predetermined temperature, thermal motor 64 retracts and return spring 70 urges central shaft 66 upwardly until return spring 70 engages annular ring 62 and lifts it off valve seat 60 again opening valve opening 53. When valve opening 53 is opened as indicated in FIG. 1, return spring 70 extends through valve port 54 and partially into chamber 48.

Referring to FIGS. 1, and 2, in at least one example embodiment, the heat exchanger side inlet port 50 and the main outlet port 52 are offset relative to each other along the axis of the valve assembly 38 such that the cap 80 defines part of the flow path between the heat exchanger side inlet port 50 and the main outlet port 52. Referring to FIGS. 4-7, dashed line 96 is used to illustrate this flow path. The closure cap 80 includes an upper cylindrical plug portion 86 and a spaced apart disk-like annular ring portion 88, that are joined together by a cage-like structure that includes a series spaced apart vanes or elongate struts 89 interconnecting the opposed plug portion 86 and ring portion 88. The closure cap plug portion 86 defines an outer cylindrical wall 90 sized to fit in the upper end of chamber 48, and a larger diameter disk-like head 92. Chamber 48 has a cap seat 94 (see FIGS. 1,2) formed about a circumference of an circular assembly opening 81 in which enlarged cap head 92 is located. As illustrated, the axial recess 78 (which receives an end of thermal motor piston 76) is centrally defined within the plug portion 86. An annular groove 102 may be formed in an outer surface of the outer cylindrical wall 90.

The lower ring portion 88 of the cap defines a central flow opening or valve port 87, such that in at least one mode of operation, fluid flowing in from heat exchanger side port 50 (which is aligned with the ribbed area of the cap) can pass between ribs 96 and through the valve port 87 and then out of main outlet port 52 as illustrated by flow path 96. Referring to FIGS. 3 and 4 in particular, the thermal motor 64 has an enlarged cylindrical head portion 65 at the upper end of central shaft 66. The above-mentioned shoulder seat 72 for spring 74 is provided by head portion 65. Additionally head portion 65 has an upper surface 84 for cooperating with a lower surface 82 of closure cap lower ring portion 88 to restrict the fluid flow through valve port 87 in a cold state of operation. In FIG. 1, it will be noted that the upper surface 84 of thermal actuator 64 is cooperating with the lower surface 82 of cap 80 to block valve port 87, whereas in FIG. 2 the upper surface 84 of thermal actuator 64 is spaced apart from the lower surface 82 of cap 80 to facilitate flow path 96 through opening 87.

Cap 80 can be ultrasonically welded to housing 46 (when housing 46 is plastic) in order to seal the opening 81. In some embodiments plastic cap 80 could be replaced with a metal cap having an annular sealing ring, and/or could be secured in place through some other non-permanent means such as, for example, with a C-clip, or by being threaded, or having a twist lock configuration, rather than through ultrasonic welding. In some example embodiments, cap 80 does not include lower portion 88, struts 89, or valve port 87.

An example of the operation of by-pass valve 14 in a transmission oil cooling circuit will now be described with reference to FIGS. 1 and 2. In one example embodiment, port 58 functions as the main inlet port for the valve 14 and receives hot transmission oil from a transmission (either directly or through a converter), and port 52 functions as the main outlet port for the valve 14 and returns the transmission oil to the transmission after it has been cooled by heat exchanger 12. Heat exchanger side output port 56 delivers the oil received from main inlet port 58 to the heat exchanger 12 for cooling, and heat exchanger side input port 50 receives cooled oil from the heat exchanger 12.

FIG. 1 illustrates the by-pass valve 14 in a cold or full by-pass state, in which the by-pass valve port 54 located between main inlet port 58 and the main outlet port 52 is open and the secondary valve port 87 between the heat exchanger side inlet port 50 and the main outlet port 52 is closed. In the full by-pass state, the flow resistance offered by the heat exchanger 12 and closed secondary valve port 87 are such that substantially all of the transmission oil entering the by-pass valve port 54 will by-pass the heat exchanger 12 and instead be routed directly through open bypass valve port 54 and out the main outlet port 52. However, as the transmission oil warms up, the warm oil flowing in camber 48 causes the thermal actuator 64 to push the annular ring 62 towards seat 60 to gradually close by-pass port 54 (and at the same time move the thermal actuator head 65 away from cap 80 and gradually open secondary port 87). Thus, as the oil starts to warm up, flow through conduit 32 and heat exchanger 12 starts to increase, and by the time the oil reaches the desired operating temperature (for example 80° C.), full flow is occurring through heat exchanger 12 and valve member 62 closes valve port 54 discontinuing the by-pass flow.

Although in the illustrated embodiments the interaction of the thermal motor head 65 with cap surface 82 to close the secondary valve port 87 acts against the flow of oil through the heat exchanger 12 when the by-pass valve 14 is in the full by-pass state of FIG. 1, in at least some embodiments the flow resistance offered by heat exchanger 12 on its own is sufficient to prevent any substantial oil flow through the heat exchanger when the by-pass port 54 is open. Accordingly the use of a secondary valve port 87 integrated into cap 80 is not required in at least some example embodiments. Furthermore, it will be appreciated that the roles of ports 34 and 36 could be reversed along with the roles of ports 50 and 56.

Having described the overall configuration and operation of an example embodiment of the by-pass valve 14, particular features of the by-pass valve will now be described in greater detail.

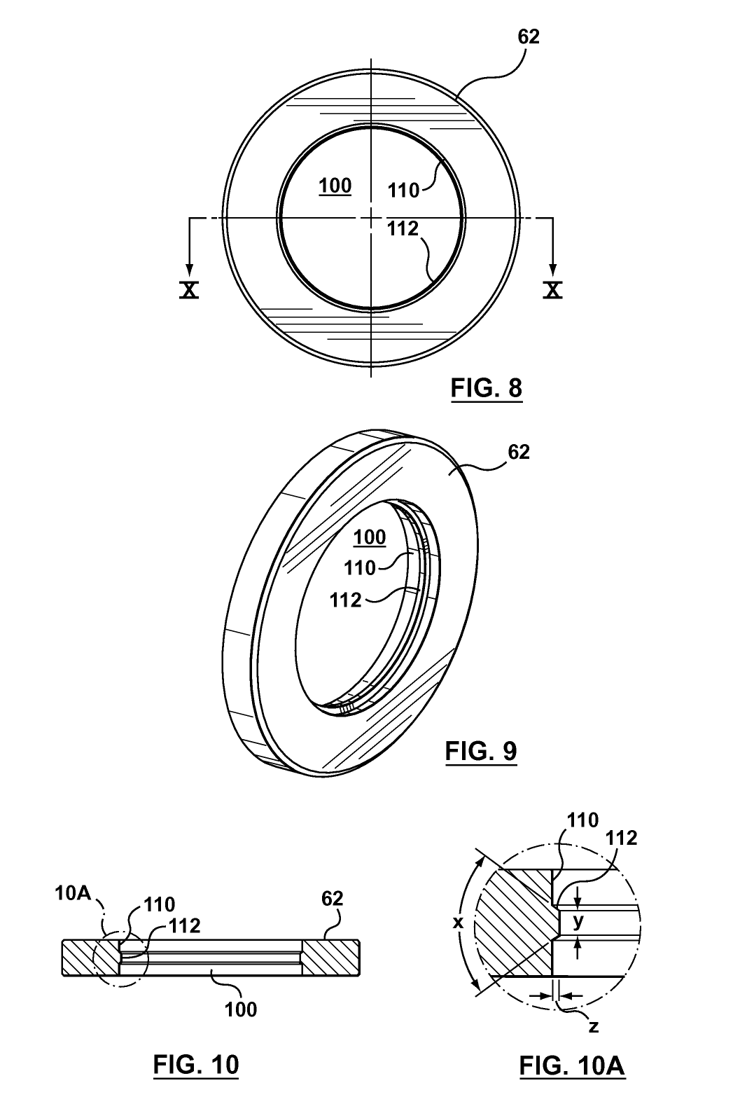

As shown in FIGS. 1-3, the valve assembly 38 includes a washer-like annular ring 62 which slides along the shaft 66 and which functions with the closed end portion 68 of the shaft 66 to close the by-pass valve port 54 when the by-pass valve 14 is operating in a hot state. The annular ring 62 should fit around the shaft 66 in such a manner that the ring 62 can slide along the shaft 66 without binding, but at the same time be tight enough around the shaft 66 to prevent fluid from leaking through the area of contact between the inner surface of the annular ring 62 and the outer surface of the shaft 66. In some designs, washers made of brass or other metal alloy or steel and having a uniform inner surface can be used for annular ring 62 in valve assemblies. However, achieving a fit around shaft 66 that is both non-binding and leak resistant can be challenging using such designs. Accordingly, in at least some example embodiments of the invention, annular ring 62 takes the configuration shown FIGS. 8-10.

The washer-like annular ring 62 of FIGS. 8-10 is formed from a synthetic material such as plastic. For example, for various applications suitable materials for annular ring 62 can be polyamide 4/6 or polyamide 66, although other suitable nylons and other suitable plastics can be used. The annular ring 62 of FIGS. 8-10 also has a substantially smooth cylindrical inner surface 110 defining a central opening 100 through which shaft 66 passes, with a circumferential inwardly extending wiper or rib 112 protruding inward from a mid-point of the surface 110 for slidably engaging the outer surface of the actuator shaft 66. As seen in the FIG. 10, the rib 112 has a thickness Y that is a fraction of the thickness of the rest of the ring 62. By way of non-limiting example, the rib 112 may be ⅓ to 1/7 of the thickness of the rest of the ring 62. In the presently described embodiment, the annular ring 62 is formed as a unitary structure with the rib 112 being formed integrally with, and from the same material as, the rest of the annular ring 62. In one non-limiting illustrative example, annular ring 62 has a thickness of 3 mm, with central opening 100 having an inner diameter of 8.43 to 8.48 mm, and, referring to enlarged FIG. 10A, the inner surface of rib 112 extends Z=0.1 mm from the rest of surface 110 and has a thickness at its shaft engaging surface of Y=0.5 mm, with rib 112 also having side-walls that diverge outwardly at X=60°. Such dimensions are provided as an illustrative example only, and the exact dimensions of the rib 112 can vary greatly depending on its cooperating environment. In example embodiments, the inside diameter of the annular ring 62 is selected based on the LMC (“least material condition”) and MMC (“maximum material condition”) dimensions specified for the central shaft 66. When the shaft 66 is at LMC, then a minimal clearance between the annular ring 62 and the shaft 66 is desired, and when the shaft 66 is at MMC, then minimal interference between the annular ring 62 and the shaft 66 is desired. The dimensions of the wiper or rib 112 are selected to facilitate use of the annular ring 62 over the LMC-MMC range of central shaft 66, while providing a leak-resistant non-binding seal between the ring 62 and the shaft 66.

In some applications, the use of an annular ring 62 that is formed from a synthetic material and which has an internal rib 112 on its inner surface 110 can have a tight sliding interface with the shaft 66, mitigating against leakage while permitting the ring 62 to slide along shaft 66 without binding. The internal rib 112 functions as a wiper along the central shaft 66. In some embodiments, the rib 112 need not be a straight rib, but rather could include waves or a sinusoidal pattern, for example, along its length around the circumference of the opening 100. The rib 112 also functions as a centering structure in that it keeps the ring 62 centered relative to the central shaft 66. In the absence of ring 62, the ring opening 100 may be off-set relative to the central axis of shaft 66, allowing greater potential for leakage through the gap between the inner surface of the ring opening 100 and the shaft 66 than a centered ring might permit.

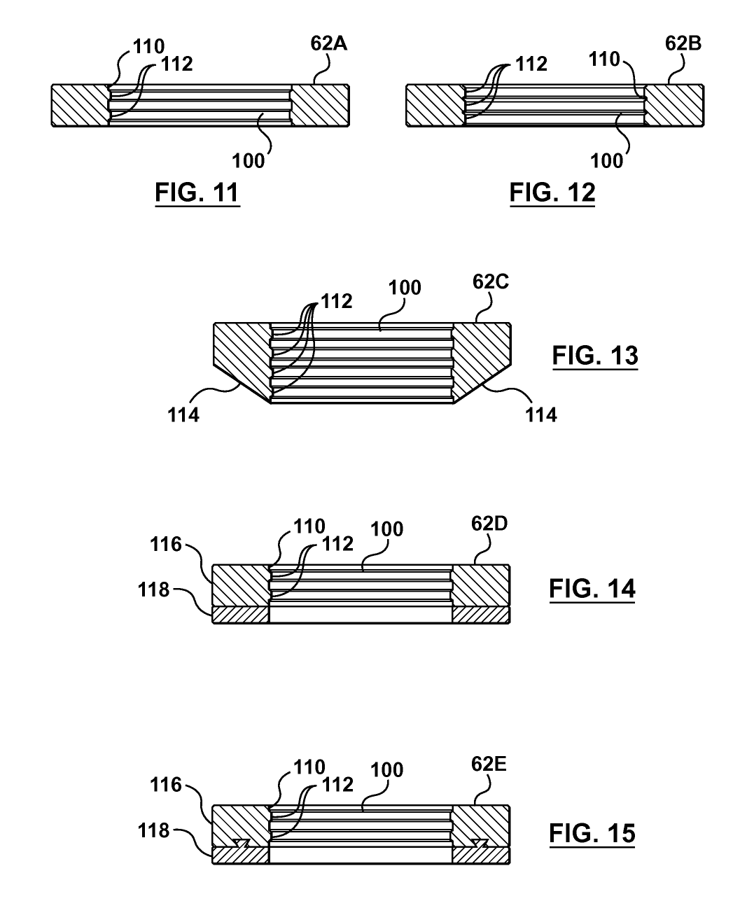

Variations of annular ring 62 can also be used in various example embodiments. In this regard, FIG. 11 shows a further embodiment of an annular ring 62A, which is identical to ring 62 except that ring 62A includes two spaced apart parallel circumferential ribs 112 protruding inward from the inner surface 110. The two rings 112 in FIG. 11 are axially spaced from each other (relative to an axis of the opening 100). In some applications, having two ribs 112 in contact with the shaft 66 can help improve the perpendicularity of the annular ring relative to the shaft 66, as well as offering increased leak resistance and robustness. For similar reasons, more than two ribs 112 may prove beneficial in some applications, and in this regard, FIG. 12 shows a further embodiment of an annular ring 62B that is similar to rings 62 and 62A, except that annular ring 62B has three axially spaced apart parallel circumferential ribs 112 protruding inward from the inner surface 110.

FIG. 13 shows yet another example embodiment of an annular ring 62C, which is similar to annular rings 62, 62A, 62B described above, except that ring 62C has four internal axially spaced rings 112 and a conical, tapering lower surface 114 for engaging the valve seat 60. The interaction or tapering surface 114 with the valve seat 60 can further assist in maintaining the perpendicularity of the ring on shaft 66 and in forming a seal with the valve seat 60. In some embodiments the valve seat 60 could have a cooperating conical surface. A tapering, conical seat engaging surface 114 could also be used with any of annular rings 62, 62A and 62B described above, or rings 62D and 62E described below.

FIG. 14 shows a further annular ring 62D according to another example embodiment of the invention. Annular ring 62D is made up of two separate stacked annular rings 116 and 118. First annular ring 116 is the same as or similar to any of annular rings 62, 62A or 62B discussed above, and includes one or more inner annular ribs 112. However, the valve seat-side second annular ring 118 is formed from a softer, lower durometer plastic material than the first annular ring 16. The softer material of second ring 118 can in some applications provide a better seal with the valve seat 60 than the harder first ring 116, with the inner ribbed harder first ring 16 providing a good seal with the shaft 66 and rigidity for providing robustness and maintaining perpendicularity of the combined ring 62D with the shaft.

FIG. 15 shows yet a further annular ring 62E according to another example embodiment of the invention. Ring 62E is the same as annular ring 62D, except that instead of the first and second rings 116 and 118 being physically separate, the harder and softer rings 116, 118 are connected or fused together, for example by being over molded to have interconnecting ribs and grooves as shown in FIG. 15. In some example embodiments, annular rings 62D and 62E may not include inner ribs 112.

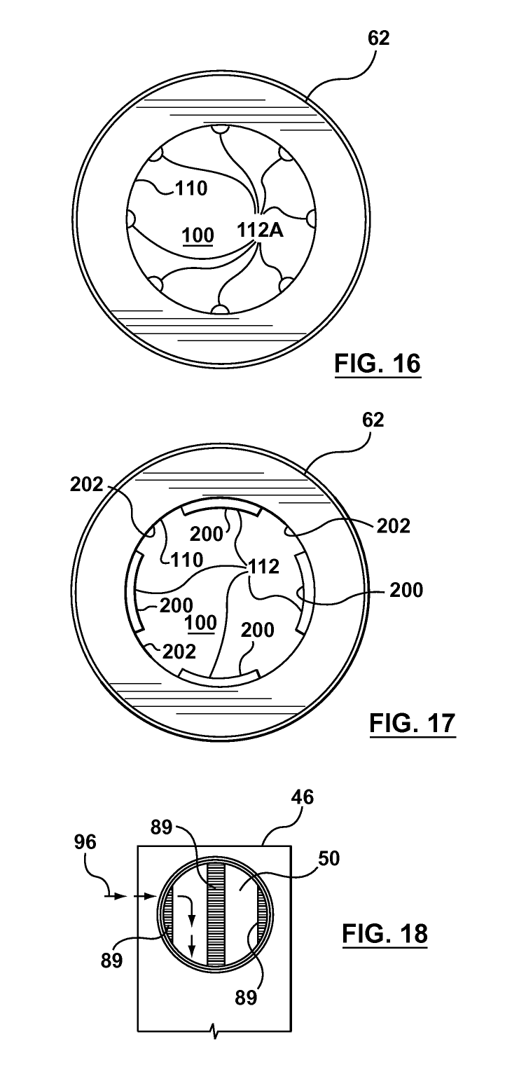

FIG. 16 shows yet another example embodiment of an annular ring 62 that is similar to the annular ring of FIGS. 8-10 except that the continuous rib 112 has been replaced with a series of inward protrusions 112A that are circumferentially spaced around the inner surface 110 of ring 62. Similar to rib 112, the inward protrusions 112A function as a centering structure for centering the ring 62 on the central shaft 66. Protrusions 112A can have the same thickness as the rest of ring 62, or be less thick. Although eight protrusions 112A are shown in FIG. 16, more or fewer protrusions could be provided.

FIG. 17 shows yet another example embodiment of an annular ring 62 that is similar to the annular ring of FIGS. 8-10 except that the continuous rib 112 has been replaced with a circumferential rib 112 that is non-continuous in that it contains semi-circular rib portions 200 on surface 110 that are separated by gaps 202. Similar to continuous rib 112 of FIG. 8, the non-continuous rib 112 of FIG. 17 functions as a centering structure for centering the ring 62 on the central shaft 66.

Features of an example embodiment of closure cap 80 will now be discussed in greater detail with reference to FIGS. 5-7. As noted above, the illustrated cap 80 defines a fluid flow path 96 that passes between molded vanes or struts 89 and through central valve port opening 87 of ring portion 88. The surface 82 surrounding valve port 87 provides a valve seat that cooperates with the upper surface 84 of the thermal motor 64 to at least partially restrict flow path 96 in the cold state of the bypass port 14. In the illustrated embodiment, the struts 89 are arranged in a cage-like configuration around the central valve port opening 87 and the spacing and cross-sectional dimension of struts 89 are selected so that regardless of the rotational orientation of the cap in the housing 46, the struts 89 will have minimal impact on the flow path 96. In this regard, FIG. 16 shows a view though the inlet port 50 of the by-pass valve 14, showing the struts 89 in one possible orientation of the cap 80 relative to the inlet port 50. In FIG. 18, three struts 89 can be seen through inlet port 50, however the location of struts 89 can vary depending on the orientation of the cap 80 when it is secured in place in the housing 46. The ribbed configuration of cap 80 permits the flow path 96 to be substantially unaffected by the relative orientation of the cap 80 to the flow port 50, thereby decreasing variations in by-pass port 14 operation that could otherwise be introduced during assembly.

Turning again to FIGS. 4 and 7, the lower ring portion 88 of the cap 80 has a circumferential outer surface 200 for sealingly engaging an inner wall of the chamber 48 below inlet port 50 and above outlet port 42. In at least one example embodiment, a wiper comprising an integral circumferential bead or rib 202 that protrudes from the outer surface 200 is provided for improving the seal between the lower ring portion 88 and the wall of the chamber 48. In at least some example embodiments, a pliable o-ring is located in groove 102 in the closure cap plug portion 86 of cap head 92 for engaging the wall of chamber 48 to seal the opening 81 when cap 80 is installed. FIG. 1 illustrates such an O-ring 204.

Having described example embodiments of the invention, it will be appreciated that various modifications in addition to those already set forth can be made to the structures described above. For example, the by-pass valve has been described above for use with an automotive transmission oil cooler as the heat exchanger, but the by-pass valves could be used with any other types of heat exchanger, such as fuel cooling heat exchangers, and in non-automotive applications as well. Other types of thermal actuators can be used than the wax-type actuator 64. For instances, bimetallic or shape memory alloy thermal responsive actuators could be used to move a valve member.

Additionally, the slidably mounted annular ring 62 could be used in by-pass valve designs different from those described above—for example, in addition to acting as a thermal valve, the valve assembly 38 also operates as a pressure valve in that in the hot state closed position of FIG. 2, the by-pass valve acts as a pressure relief valve by opening valve port 60 when the pressure at port 58 is sufficient to overcome the bias force applied on annular ring 62 by spring 74. Thus, in some embodiments, annular ring 62 could be used in a pressure-only by-pass valve environment (for example, in an environment with a stationary shaft 66 on which the annular ring 62 is slidably mounted and biased into a closed position against a valve seat 60 by a bias member such as spring 74).

As will be apparent to those skilled in the art in the light of the foregoing disclosure, many alterations and modifications are possible in the practice of this invention. Accordingly, the scope of the invention is to be construed in accordance with the substance defined by the following claims.

What is claimed is:

1. A by-pass valve comprising:
a housing defining a chamber therein, and a by-pass valve port and a first port communicating with the chamber, the by-pass valve port having a central axis and a peripheral valve seat; and
a valve assembly comprising a central shaft disposed along said central axis, and an annular ring slidably mounted on the central shaft for movement between a closed position in which the annular ring engages the valve seat and an open position in which the annular ring is spaced apart from the valve seat, the annular ring having a cylindrical inner surface surrounding the central shaft with a first circumferential rib extending inward from a portion of the inner surface and slidably engaging the central shaft.

2. The by-pass valve of claim 1 wherein the first circumferential rib is continuous around the entire inner surface.

3. The by-pass valve of claim 1 wherein the first circumferential rib is non-continuous with circumferentially spaced semi-circular rib portions located on the inner surface.

4. The by-pass valve of claim 1 wherein the annular ring includes a second circumferential rib extending inward from the inner surface and slidably engaging the central shaft.

5. The by-pass valve of claim 4 wherein the first and second circumferential ribs are spaced apart from each other.

6. The by-pass valve of claim 4 wherein the annular ring includes at least a third circumferential rib extending inward from the inner surface and slidably engaging the central shaft.

7. The by-pass valve of claim 1 wherein the annular ring comprises adjacent first and second annular portions each surrounding and slidably mounted to the central shaft, one of the annular portions being formed from a material that is softer than a material that the other annular portion is formed from.

8. The by-pass valve of claim 7 wherein the second annular portion is located between the first annular portion and the valve seat and engages the valve seat when the annular ring is in the closed position, and wherein the second annular portion is formed from the softer material.

9. The by-pass valve of claim 8 wherein the first annular portion and the second annular portion of the annular ring are separate pieces that are not physically secured together.

10. The by-pass valve of claim 9 wherein the first annular portion and the second annular portion of the annular ring are secured to each other through interconnecting sections.

11. The by-pass valve of claim 8 wherein the annular rib is integrally formed with the first annular portion.

12. The by-pass valve of claim 1 wherein the housing defines a second port communicating with the chamber and an assembly opening that is located opposite the valve seat, the by-pass valve comprising a molded plastic closure cap mounted in the assembly opening, the closure cap having a cylindrical plug section sealing the assembly opening, an annular ring section axially spaced from the plug section, and a plurality of elongate struts joining the plug and ring sections, the second port opening into the chamber at a location between the plug section and the ring section wherein a flow path between the second port and the first port passes through a central opening of the ring section.

13. The by-pass valve of claim 12 wherein the dimensions and relative spacing of the struts are selected so that a flow of fluid through the closure cap is substantially unaffected by a relative rotational positioning of the closure cap to the second port.

14. The by-pass valve of claim 13 wherein the ring section defines a surface around the ring section central opening, wherein the central shaft of the valve assembly is mounted to reciprocate along the central axis, the central shaft having a first end portion for cooperating with the surface around the ring section central opening to close the ring section central opening when the by-pass valve port is open.

15. The by-pass valve of claim 12 wherein the ring section has an outer surface for cooperating with an inner surface of the chamber, the outer surface having formed thereon a circumferential rib for sealingly engaging the chamber inner surface.

16. The by-pass valve of claim 1 wherein the by-pass valve is for use in a heat exchanger circuit, and the valve assembly comprises:
a temperature sensitive actuator that includes the central shaft, the central shaft being mounted to reciprocate along the central axis in response to changes in a temperature of the temperature sensitive actuator;
a first bias member mounted on the central shaft urging the annular ring toward the valve seat; and
a second bias member mounted in the housing for urging the central shaft closed end portion to retract and open the by-pass valve port.

17. A by-pass valve comprising:
a housing defining a chamber therein, and a by-pass valve port and a first port communicating with the chamber, the by-pass valve port having a central axis and a peripheral valve seat; and
a valve assembly comprising a central shaft disposed along said central axis, and an annular ring slidably mounted on the central shaft for movement between a closed position in which the annular ring engages the valve seat and an open position in which the annular ring is spaced apart from the valve seat, wherein the annular ring comprises adjacent first and second annular portions each surrounding and slidably mounted to the central shaft, one of the annular portions being formed from a material that is softer than a material that the other annular portion is formed from.

18. The by-pass valve of claim 17 wherein the second annular portion is located between the first annular portion and the valve seat and engages the valve seat when the annular ring is in the closed position, and wherein the second annular portion is formed from the softer material.

19. The by-pass valve of claim 18 wherein the first annular portion and the second annular portion of the annular ring are separate pieces that are not physically secured together.

20. The by-pass valve of claim 19 wherein the first annular portion and the second annular portion of the annular ring are secured to each other through interconnecting sections.

21. A by-pass valve comprising:
a housing defining a chamber therein, and a by-pass valve port and a first port communicating with the chamber, the by-pass valve port having a central axis and a peripheral valve seat; and
a valve assembly comprising a central shaft disposed along said central axis, and an annular ring slidably mounted on the central shaft for movement between a closed position in which the annular ring engages the valve seat and an open position in which the annular ring is spaced apart from the valve seat, the annular ring having a cylindrical inner surface surrounding the central shaft with a centering structure extending inward from a portion of the inner surface and slidably engaging the central shaft for keeping the annular ring centered relative to the central shaft.

22. The by-pass valve of claim 21 wherein the centering structure includes a plurality of inward protrusions that are circumferentially spaced apart from each other about the inner surface.
